(19) United States
(12) Patent Application Publication
(10) Pub. No.: US 2026/0328233 A1
(43) Pub. Date: Oct. 22, 2026

(54) Angled Grommet

(71) Applicant: Illinois Tool Works Inc., Glenview, IL (US)

(72) Inventor: Emily Roetker, Joliet, IL (US)

(21) Appl. No.: 19/644,298

(22) Filed: Apr. 10, 2026

Related U.S. Application Data
(60) Provisional application No. 63/790,238, filed on Apr. 17, 2025.

(51) Int. Cl. F16B 5/02

(52) U.S. Cl. CPC F16B 5/0258

(57) ABSTRACT

An adaptive grommet is configured to be received within an opening of a component and to conform to non-planar geometries. The adaptive grommet includes a grommet body and an apron extending therefrom, the apron including retention features configured to engage a perimeter of the opening. The adaptive grommet defines a bend axis separating first and second grommet regions, allowing relative movement between the regions to accommodate angular or curved surfaces. In certain embodiments, the apron includes inner and outer sidewalls forming, for example, a V-shaped cross-section to provide outward biasing force, and a plurality of clips to retain the grommet within the opening. The adaptive grommet may include one or more notches to facilitate bending and may be formed as a unitary polymeric structure.

### RELATED APPLICATIONS

The present application claims priority to U.S. Provisional Patent Application No. 63/790,238, filed Apr. 17, 2025, and entitled “Angled Grommet,” which is hereby incorporated by reference in its entirety.

### BACKGROUND

Automotive components require fastening solutions that are straightforward to manufacture and assemble, while delivering high reliability and operational efficiency. A grommet is a mechanical component used to reinforce holes (e.g., as part of a fastening assembly), protect cables or materials from abrasion, and provide a secure interface between different parts of a system. Grommets can be used in applications ranging from electrical wiring and plumbing to automotive assemblies and consumer electronics. A function is to prevent damage caused by sharp edges, vibration, or friction while also helping to organize and stabilize components passing through openings.

Traditional grommet designs are typically optimized for flat, uniform surfaces and standardized hole geometries; however, many modern applications involve irregular, curved, or uneven surfaces where conventional grommets do not perform effectively. In these cases, poor fitment can lead to inadequate sealing, reduced durability, or increased wear, including on cables and surrounding materials.

Accordingly, there is a need for improved grommet designs that can adapt to non-flat surfaces and provide reliable performance under varied conditions. Such improved grommet designs would enhance protection, extend component lifespan, and enable more flexible integration across a wider range of applications.

### SUMMARY

The present disclosure relates generally to a grommet, substantially as illustrated by and described in connection with at least one of the figures, as set forth more completely in the claims. More particularly, to an angled or adaptive grommet for use when forming a connection between two components, such as vehicular components, passing cables, plugging holes, or other applications where a reinforced and/or protected opening (e.g., avoiding sharp edges) in a component is desired.

### DRAWINGS

The foregoing and other objects, features, and advantages of the devices, systems, and methods described herein will be apparent from the following description of particular examples thereof, as illustrated in the accompanying figures, where like or similar reference numbers refer to like or similar structures. The figures are not necessarily to scale, emphasis instead being placed upon illustrating the principles of the devices, systems, and methods described herein.

FIG. 1a illustrates a side assembly view of a fastening system with a fastener assembly having an adaptive grommet in accordance with an aspect of this disclosure configured in a first orientation.

FIG. 1b illustrates a side assembled view of the fastening system of FIG. 1a.

FIG. 1c illustrates a side assembly view of a fastening system with a fastener assembly having an adaptive grommet in accordance with an aspect of this disclosure configured in a second orientation.

FIG. 1d illustrates a side assembled view of the fastening system of FIG. 1c.

FIG. 2a illustrates a topside isometric view of the adaptive grommet of FIGS. 1a through 1d.

FIG. 2b illustrates an underside isometric view of the adaptive grommet.

FIG. 2c illustrates a top plan view of the adaptive grommet.

FIG. 2d illustrates a bottom plan view of the adaptive grommet.

FIG. 2e illustrates an elevation view of a first side of the adaptive grommet.

FIG. 2f illustrates an elevation view of a second side of the adaptive grommet.

FIG. 2g illustrates an elevation view of a third side of the adaptive grommet.

FIG. 2h illustrates an elevation view of a fourth side of the adaptive grommet.

FIG. 2i illustrates a cross-sectional isometric view of the adaptive grommet taken along cutline A-A (FIG. 2c).

FIG. 2j illustrates a cross-sectional side view of the adaptive grommet taken along cutline A-A (FIG. 2c).

FIG. 3a illustrates a topside isometric view of the adaptive grommet for FIGS. 1a through 1d.

FIG. 3b illustrates an underside isometric view of the adaptive grommet.

FIG. 3c illustrates a top plan view of the adaptive grommet.

FIG. 3d illustrates a bottom plan view of the adaptive grommet.

FIG. 3e illustrates an elevation view of a first side of the adaptive grommet.

FIG. 3f illustrates an elevation view of a second side of the adaptive grommet.

FIG. 3g illustrates an elevation view of a third side of the adaptive grommet.

FIG. 3h illustrates an elevation view of a fourth side of the adaptive grommet.

FIG. 3i illustrates a cross-sectional isometric view of the adaptive grommet taken along cutline B-B (FIG. 3c).

FIG. 3j illustrates a cross-sectional side view of the adaptive grommet taken along cutline B-B (FIG. 3c).

### DESCRIPTION

References to items in the singular should be understood to include items in the plural, and vice versa, unless explicitly stated otherwise or clear from the text. Grammatical conjunctions are intended to express any and all disjunctive and conjunctive combinations of conjoined clauses, sentences, words, and the like, unless otherwise stated or clear from the context. Recitation of ranges of values herein are not intended to be limiting, referring instead individually to any and all values falling within and/or including the range, unless otherwise indicated herein, and each separate value within such a range is incorporated into the specification as if it were individually recited herein. In the following description, it is understood that terms such as “first,” “second,” “top,” “bottom,” “side,” “front,” “back,” and the like are words of convenience and are not to be construed as limiting terms. For example, while in some examples a first side is located adjacent or near a second side, the terms “first side” and “second side” do not imply any specific order in which the sides are ordered. It will be understood that directional references (e.g., upper, lower, upwardly, downwardly) are used for convenience with respect to the orientation shown in the figures and are not intended to limit the scope of the disclosure.

The terms “about,” “approximately,” “substantially,” or the like, when accompanying a numerical value, are to be construed as indicating a deviation as would be appreciated by one of ordinary skill in the art to operate satisfactorily for an intended purpose. Ranges of values and/or numeric values are provided herein as examples only, and do not constitute a limitation on the scope of the disclosure. The use of any and all examples, or exemplary language (“e.g.,” “such as,” or the like) provided herein, is intended merely to better illuminate the disclosed examples and does not pose a limitation on the scope of the disclosure. The terms “e.g.,” and “for example” set off lists of one or more non-limiting examples, instances, or illustrations. Terms such as “can,” “may,” and “in certain examples” are used to reflect that variations are contemplated. No language in the specification should be construed as indicating any unclaimed element as essential to the practice of the disclosed examples.

The term “and/or” means any one or more of the items in the list joined by “and/or.” As an example, “x and/or y” means any element of the three-element set {(x), (y), (x, y)}. In other words, “x and/or y” means “one or both of x and y”. As another example, “x, y, and/or z” means any element of the seven-element set {(x), (y), (z), (x, y), (x, z), (y, z), (x, y, z)}. In other words, “x, y, and/or z” means “one or more of x, y, and z.”

Disclosed herein is an adaptive grommet (e.g., an angled grommet) configured to adapt to non-flat surfaces (e.g., bend, curved, and/or other non-planar surfaces). The adaptive grommet offers several advantages over alternative configurations. For example, if the adaptive grommet were molded in an angled position with angled retention features (e.g., clips), such a configuration would increase design and manufacturing complexity and require more expensive tooling. Alternatively, if the adaptive grommet were molded in an angled position with retention features aligned with the line of draw, the resulting structure would exhibit decreased and non-uniform retention strength. Further, if the adaptive grommet were molded in a flat configuration without notches or other compliance features, subsequent bending during installation would likely result in part distortion and poor retention performance.

In one example, an adaptive grommet is configured to be received within an opening of a component, the adaptive grommet comprising a grommet body and an apron extending from the grommet body, wherein the apron includes a plurality of retention features configured to engage a perimeter of the opening, wherein the adaptive grommet defines a bend axis such that a first grommet region and a second grommet region are movable relative to one another to conform to a non-planar surface, and, in some examples, wherein the adaptive grommet includes at least one notch associated with the bend axis and configured to facilitate bending of the adaptive grommet along the bend axis.

In another example, the adaptive grommet of the previous example includes an apron having an inner sidewall and an outer sidewall forming a generally V-shaped cross-section.

In some examples, the outer sidewall includes a free end defining a lip configured to abut a surface of the component.

In one example, the inner sidewall and the outer sidewall cooperate to generate a spring force that biases the apron outwardly against the opening.

In another example, the plurality of retention features comprise clips configured to elastically deflect during insertion into the opening.

In some examples, the clips are distributed about a perimeter of the apron.

In one example, the apron includes twelve clips arranged with three clips on each of four sides.

In another example, the apron defines a gap between an underside of a lip and an upper surface of the retention features, the gap being configured to receive a portion of the component.

In some examples, the at least one notch comprises a pair of aligned notches defining the bend axis.

In one example, the notches reduce a thickness of material at the bend axis to facilitate bending.

In another example, an additional notch is positioned to permit bending about an axis transverse to the bend axis.

In some examples, the grommet body defines a grommet opening.

In one example, the grommet opening is generally circular.

In another example, the grommet opening is offset relative to a geometric center of the grommet body.

In some examples, the grommet body is generally planar and defines a generally rectangular perimeter.

In one example, the grommet body is solid and omits an opening.

In another example, the grommet body and the apron are formed as a unitary structure.

In some examples, the grommet body and the apron are separately formed and joined together.

In one example, the adaptive grommet is formed from a polymeric material.

In another example, the adaptive grommet is configured to flex in opposite directions along the bend axis to accommodate differing angular orientations of the component.

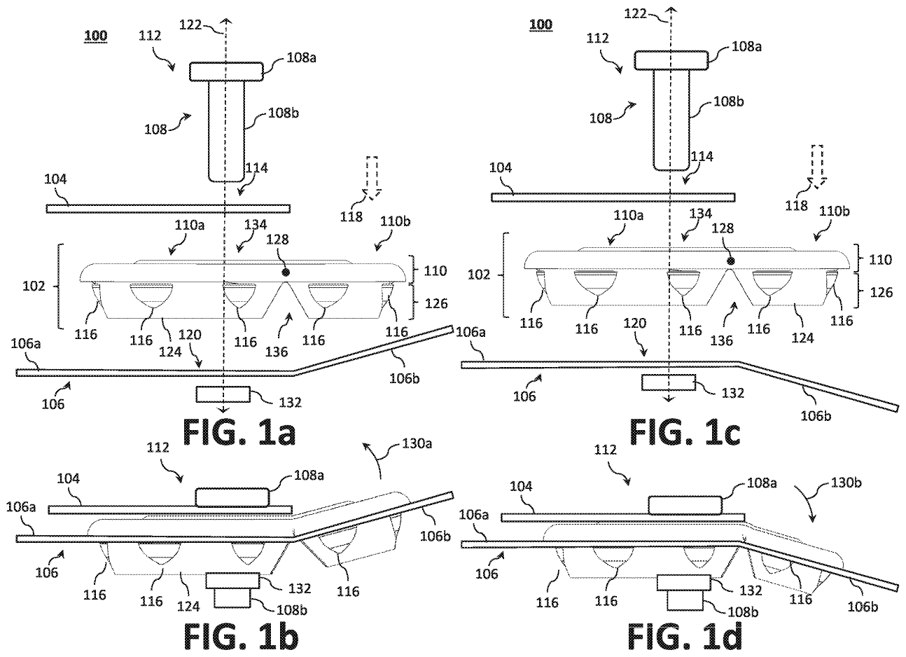

FIGS. 1a through 1d illustrate assembly and assembled views of a fastening system 100 including a fastener assembly 112 having an adaptive grommet 102. FIGS. 1a and 1b show the fastening system 100 in a first orientation (upward as indicated by arrow 130a) in, respectively, an assembly view and an assembled view. FIGS. 1c and 1d show the fastening system 100 in a second orientation (downward as indicated by arrow 130b) in, respectively, an assembly view and an assembled view. These figures collectively demonstrate that the adaptive grommet 102 is capable of accommodating differing angular configurations while maintaining proper engagement within the fastening system 100.

The fastening system 100 can include a fastener assembly 112 configured to couple a first component 104 to a second component 106. The illustrated fastener assembly 112 includes a first fastener 108 (e.g., a male fastener, such as a bolt or screw), a second fastener 132 (e.g., a female fastener, such as a nut), and the adaptive grommet 102. The second fastener 132 is configured to threadedly receive the first fastener 108 along the axis 122. In certain embodiments, the second fastener 132 may be rotationally fixed relative to the second component 106, such as by clinching, welding, press-fitting, staking, or other attachment methods, such that rotation of the first fastener 108 results in axial advancement along the axis 122 without substantial rotation of the second fastener 132.

To facilitate installation of the fastener assembly 112, the first component 104 can include a first opening 114 and the second component 106 can include a second opening 120. The first opening 114 can be generally circular and dimensioned to receive at least a portion of the first fastener 108 (e.g., axially), such as the shank 108b. The second opening 120 can be generally dimensioned to receive at least a portion of the adaptive grommet 102, and in the illustrated example is generally rectangular, although other shapes are contemplated.

The adaptive grommet 102 generally defines an upper portion 110 and a lower portion 126. The upper portion 110 is generally positioned on top of, and in abutting contact with, the second component 106 when installed, while the lower portion 126 is positioned within and/or extends through the second opening 120. The lower portion 126 includes or defines retention features configured to secure the adaptive grommet 102 relative to the second component 106.

During installation, the adaptive grommet 102 can be attached to the second component 106 via insertion of the lower portion 126 into the second opening 120 in the direction indicated by arrow 118. The lower portion 126 comprises an apron 124 having a plurality of clips 116 that are configured to elastically deflect as necessary to pass through the second opening 120 and subsequently engage a perimeter of the second opening 120 to retain the adaptive grommet 102 in position. The interaction between the clips 116 and the perimeter of the second opening 120 provides a retention force sufficient to maintain placement of the adaptive grommet 102 prior to and during assembly of the fastener assembly 112.

In the illustrated examples, the second component 106 is non-planar at the installation location of the adaptive grommet 102. That is, a first portion 106a and a second portion 106b of the second component 106 are positioned at an angle relative to one another. Each of the first portion 106a and the second portion 106b is illustrated as being generally planar, although other shapes are contemplated, including curved or otherwise contoured portions. As illustrated, the second opening 120 extends from the first portion 106a to the second portion 106b, thereby bridging or spanning the bent portion therebetween. Accordingly, the adaptive grommet 102 is configured to flex, bend, and otherwise conform to the non-planar shape of the second component 106.

In the example of FIGS. 1a and 1b, the second portion 106b is bent upward relative to the first portion 106a; accordingly, the adaptive grommet 102 is configured to correspondingly flex upward. Thus, as illustrated, the second grommet region 110b is bent upward relative to the first grommet region 110a. Conversely, in the example of FIGS. 1c and 1d, the second portion 106b is bent downward relative to the first portion 106a; accordingly, the adaptive grommet 102 is configured such that the second grommet region 110b is bent downward relative to the first grommet region 110a.

Each of the first opening 114 and the second opening 120 may be formed during manufacture of the respective components (e.g., stamping, punching, molding, or casting) or may be formed in a secondary operation (e.g., drilling, laser cutting, or machining). Optional chamfers, radiused edges, or lead-in features may be included to facilitate insertion, centering, and alignment of the adaptive grommet 102 and/or the first fastener 108.

The first fastener 108 can include a head 108a, a shank 108b, and, in some cases, a flange. The head 108a may be hexagonal or otherwise configured to facilitate engagement by a tool. The shank 108b may include external threads configured to mate with a corresponding internally threaded bore. The flange, when present, can increase the contact surface area between the head 108a and the first component 104, thereby distributing clamping load and reducing localized stresses. While illustrated as a bolt, other fasteners are contemplated, such as pins, studs, rivets, or other mechanical fasteners.

The second fastener 132 can include an internally threaded bore or other attachment feature configured to engage the first fastener 108. The bore may be configured to threadedly engage the externally threaded shank 108b of the first fastener 108. The second fastener 132 can be rotationally fixed relative to the second component 106 such that rotation of the first fastener 108 about the axis 122 advances the fastener axially without causing substantial rotation of the second fastener 132 or the adaptive grommet 102. While illustrated as a nut, other configurations are contemplated. In some examples, the second fastener 132 can be integrally formed with or coupled to the adaptive grommet 102. For example, the adaptive grommet 102 can include internal threads, detents, or other engagement features configured to receive and retain the first fastener 108.

In some examples, the first and second components 104, 106 may be dissimilar materials and the adaptive grommet 102 can serve to provide isolation between adjacent components (and the first and second fasteners 108, 132), thereby mitigating galvanic corrosion.

In some examples, the first and second components 104, 106 may be formed from dissimilar materials, and the adaptive grommet 102 can serve to electrically and mechanically isolate the adjacent components 104, 106 as well as the associated fasteners 108, 132. The adaptive grommet 102 can therefore also reduce or mitigate the potential for galvanic corrosion between the dissimilar materials, while also accommodating relative movement or vibration between the components.

Sealing elements may be provided to mitigate ingress of dust, dirt, water, or other environmental contaminants. For example, a compressible seal may be positioned about the perimeter of the adaptive grommet 102 to abut the second component 106 upon installation. Additionally or alternatively, a compressible seal may be positioned radially about the shank 108b and axially between the first component 104 and the underside of the head 108a to provide localized sealing at the fastener interface.

The first component 104 and the second component 106 may comprise automotive panels, trim components, structural members, pillars, dashboard components, seat frames, center consoles, fenders, sheet metal framework, or other substrates. These components may be fabricated from metals or metal alloys, synthetic or semi-synthetic polymers (including acrylonitrile butadiene styrene (ABS) and polyvinyl chloride (PVC)), composite materials (including fiberglass), or combinations thereof.

The adaptive grommet 102 may be fabricated from polymeric materials using injection molding or additive manufacturing processes, including but not limited to fused deposition modeling (FDM), stereolithography (SLA), selective laser sintering (SLS), material jetting, binder jetting, powder bed fusion, directed energy deposition, vat photopolymerization, or similar processes. Material selection may be based on desired properties such as flexibility, resilience, environmental resistance, and durability.

While particularly suitable for automotive applications, the fastening system 100 and adaptive grommet 102 are not so limited and may be employed in a wide variety of industries and environments, including but not limited to structural assemblies, appliances, enclosures, equipment housings, and other mechanical or electromechanical systems. The adaptive grommet 102, although shown in conjunction with the fastener assembly 112, may also be utilized independently of such assemblies. For example, the adaptive grommet 102 may be used in cable routing, wire management, fluid line pass-throughs, panel interfaces, or other applications where edge protection, sealing, vibration isolation, or reinforcement is desirable. Accordingly, while the adaptive grommet 102 is illustrated and described herein in connection with a first fastener 108 and a second fastener 132 for coupling two components 104, 106, it should be understood that the adaptive grommet 102 is not limited to such configurations or uses and may be adapted for use in any suitable application requiring a compliant or protective interface.

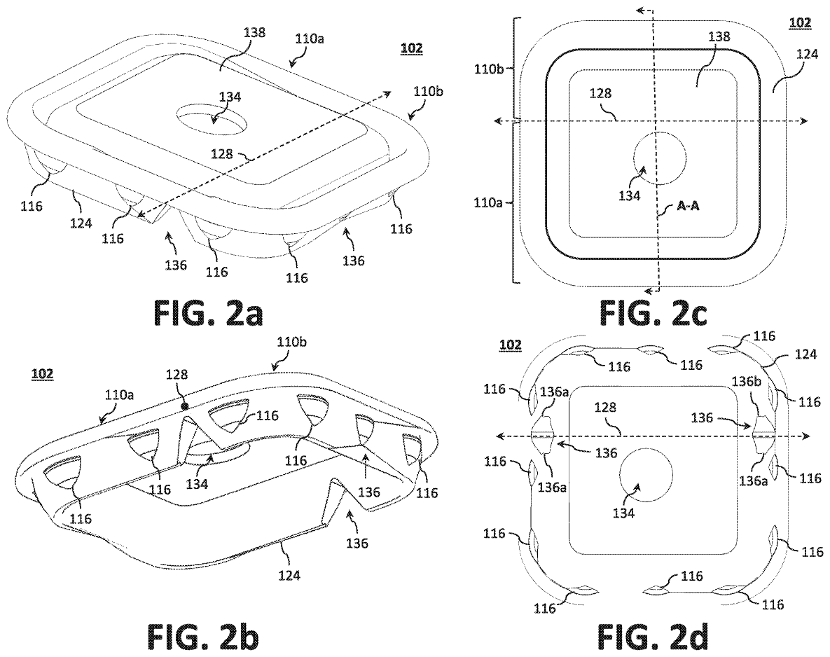

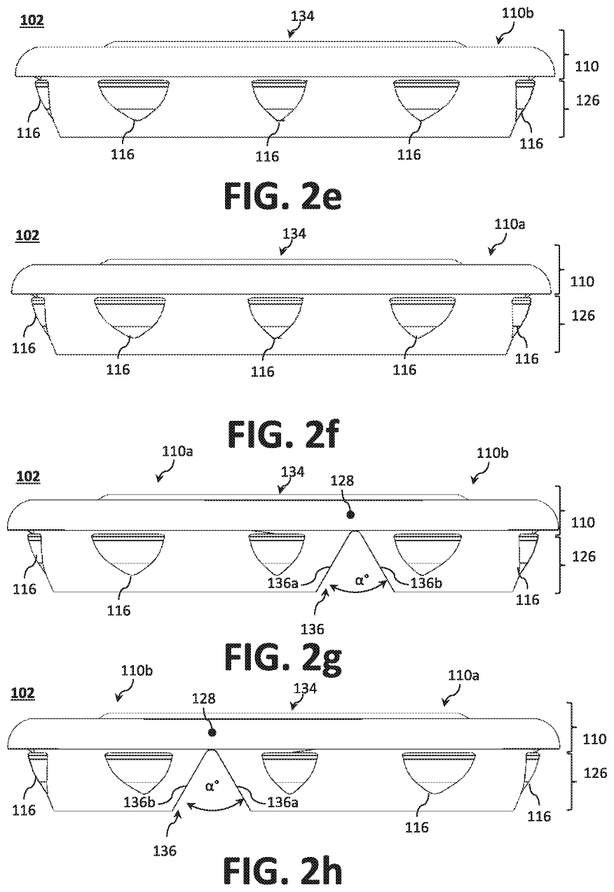

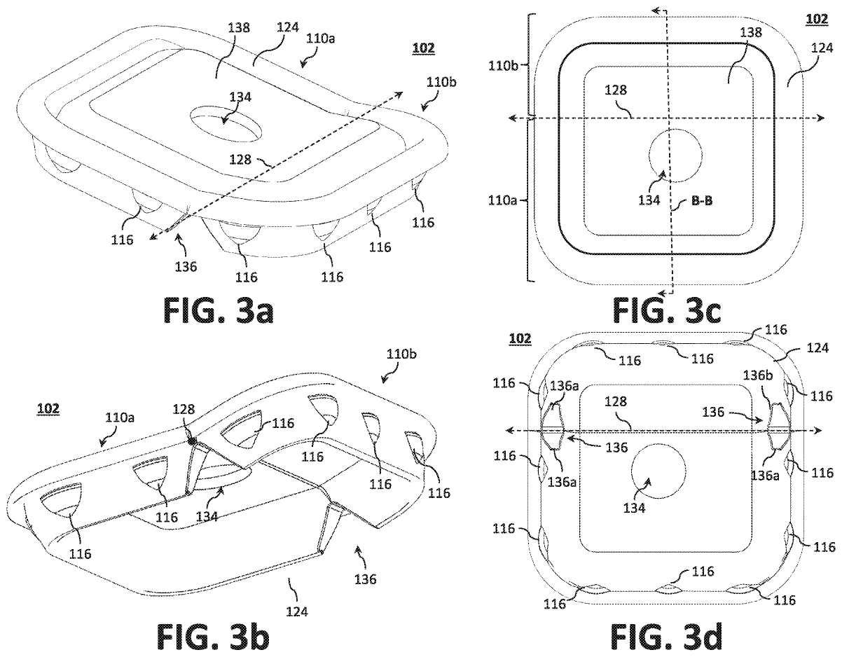

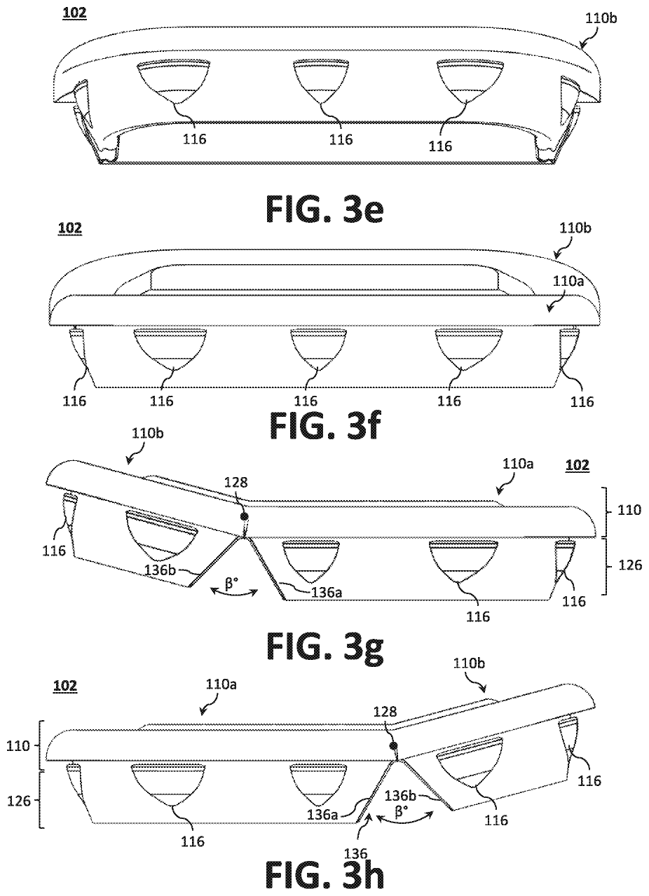

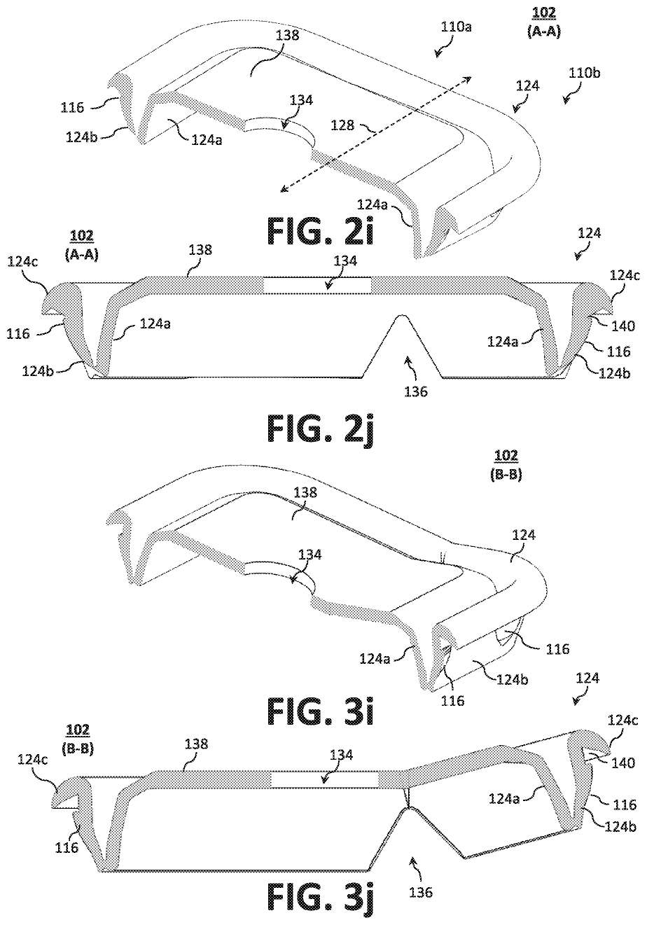

FIGS. 2a through 2j illustrate various views of the adaptive grommet 102 in a shipped or uninstalled position, while FIGS. 3a through 3j illustrate corresponding views of the adaptive grommet 102 in an installed or bent position. In these figures, the first component 104 and the second component 106 are omitted for clarity to better illustrate the structure and deformation characteristics of the adaptive grommet 102. FIGS. 2a and 2b illustrate, respectively, topside and underside isometric views. FIGS. 2c and 2d illustrate, respectively, top and bottom plan views. FIGS. 2e through 2h illustrate elevation views of first, second, third, and fourth sides of the adaptive grommet 102. FIGS. 2i and 2j illustrate, respectively, cross-sectional isometric and cross-sectional side views taken along cutline A-A of FIG. 2c. Similarly, FIGS. 3a and 3b illustrate, respectively, topside and underside isometric views. FIGS. 3c and 3d illustrate, respectively, top and bottom plan views. FIGS. 3e through 3h illustrate elevation views of first, second, third, and fourth sides of the adaptive grommet 102. FIGS. 3i and 3j illustrate, respectively, cross-sectional isometric and cross-sectional side views taken along cutline B-B of FIG. 3c.

As illustrated, the adaptive grommet 102 generally comprises a grommet body 138 and an apron 124. The grommet body 138 and the apron 124 are illustrated as a unitary structure; however, it is contemplated that these components may be separately manufactured and subsequently joined via adhesive bonding, welding, mechanical interlocking, overmolding, or other suitable attachment techniques.

The grommet body 138 defines a grommet opening 134. In the illustrated example, the grommet body 138 is generally planar and has a generally rectangular perimeter, although other shapes are contemplated, including circular, square, or irregular geometries. The grommet opening 134 is illustrated as being positioned at approximately the center of the grommet body 138, although it may be offset in certain embodiments to accommodate, for example, the location of a bend axis 128 or other geometric constraints. The grommet opening 134 may be circular as shown, although other shapes are contemplated, including ovals, slots, and polygonal openings. In other examples, the grommet body 138 may be solid (i.e., omitting the grommet opening 134) to function as a hole plug. The apron 124 is positioned around the grommet body 138 and defines or otherwise provides retention features configured to engage the second component 106.

As best illustrated in FIGS. 2i, 2j, 3i, and 3j, the apron 124 can be composed of a plurality of sidewalls, including an inner sidewall 124a and an outer sidewall 124b. In the illustrated example, the inner and outer sidewalls 124a, 124b are connected to form a generally V-shaped cross-section. The apron 124 extends generally downward from the grommet body 138 at a transverse angle relative thereto. The inner sidewall 124a is connected at one end to the grommet body 138 and at the other end to the outer sidewall 124b at an apex of the V-shape. The outer sidewall 124b is connected at one end to the inner sidewall 124a at the apex and extends to a free end that flares outward from the grommet body 138 and the apron 124. The free end of the outer sidewall 124b can define a lip 124c configured to abut a top surface of the second component 106 when installed. When installed, the apron 124, due in part to the spring force generated by the V-shaped cross-section (though other shapes are possible), exerts an outward force against the perimeter of the second opening 120 to assist in retaining the adaptive grommet 102 in place.

In the illustrated example, an exterior surface of the outer sidewall 124b defines a plurality of clips 116 distributed about the perimeter. These clips 116 are configured to deflect with the outer sidewall 124b as necessary to pass through the second opening 120 during installation. In the illustrated configuration, the apron 124 defines twelve clips 116, with three clips positioned on each of four sides. Upon installation, the second component 106 is received within a gap 140 formed between an underside of the lip 124c and an upper surface of the clips 116, thereby effectively sandwiching the second component 106 and enhancing retention. Additional or few clips are contemplated depending on the size and/or shape of the adaptive grommet 102.

The apron 124 further defines a pair of aligned notches 136 that collectively define a bend axis 128, which serves as a hinge between the first grommet region 110a and the second grommet region 110b. As illustrated, the notches 136 are generally triangular and deigned by pair of angled walls 136a, 136b. In the uninstalled position, the angled walls 136a, 136b define a first angle (α°) as illustrated in FIGS. 2g and 2h, which can increase or decrease depending upon the shape of the second component 106 upon which it is installed. For example, with reference to FIGS. 3g and 3h, the first angle (α°) can increase to a second angle (β°) when the second grommet region 110b is bent upward relative to the first grommet region 110a. The first angle (α°) can be, for example, 45 to 75 degrees, or about 60 degrees. The second angle (β°) is a function of the first angle (α°) plus or minus (depending on orientation) the angle of the second portion 106b of the second component 106.

The notches 136 reduce the amount of material at the bend axis 128, thereby facilitating bending at the bend axis 128 with reduced force and minimizing stress concentrations. In some examples, the grommet body 138 can be modified to encourage controlled bending at a desired location. For example, the grommet body 138 may be scored or thinner along the bend axis 128. In some examples, the first grommet region 110a and the second grommet region 110b can be fabricated with a living hinge therebetween (coinciding with the bend axis 128).

While two, opposed notches 136 are illustrated (e.g., one on each of the longer sides of the apron 124), additional notches 136 may be provided to facilitate additional or multi-directional bending. For example, a third notch 136 may be positioned on a shorter side of the second grommet region 110b, as indicated in FIGS. 2a and 2b. Positioning such an additional notch 136 at this location allows the second grommet region 110b to bend relative to the first grommet region 110a along the bend axis 128, as well as to bend about an axis transverse to the bend axis 128, thereby providing increased adaptability to complex or multi-axis non-planar geometries.

While specific embodiments have been described, it will be appreciated that variations in geometry, material, orientation, and configuration may be made without departing from the scope of the disclosure. The adaptive grommet 102 may be adapted for different component geometries, fastening arrangements, and environmental conditions, and may include additional or alternative features as required for a particular application.

Thus, while the present method and/or system have been described with reference to certain implementations, it will be understood by those skilled in the art that various changes may be made and equivalents may be substituted without departing from the scope of the present method and/or system. In addition, many modifications may be made to adapt a particular situation or material to the teachings of the present disclosure without departing from its scope. For example, block and/or components of disclosed examples may be combined, divided, re-arranged, and/or otherwise modified. Therefore, the present method and/or system are not limited to the particular implementations disclosed. Instead, the present method and/or system will include all implementations falling within the scope of the appended claims, both literally and under the doctrine of equivalents.

What is claimed:

1. An adaptive grommet configured to be received within an opening of a component, the adaptive grommet comprising:
a grommet body; and
an apron extending from the grommet body,
wherein the apron includes a plurality of retention features configured to engage a perimeter of the opening, and
wherein the adaptive grommet defines a bend axis such that a first grommet region and a second grommet region are movable relative to one another to conform to a non-planar surface of the component.

2. The adaptive grommet of claim 1, wherein the apron includes an inner sidewall and an outer sidewall forming a generally V-shaped cross-section.

3. The adaptive grommet of claim 2, wherein the outer sidewall includes a free end defining a lip configured to abut a surface of the component.

4. The adaptive grommet of claim 2, wherein the inner sidewall and the outer sidewall cooperate to generate a spring force that biases the apron outwardly against the opening.

5. The adaptive grommet of claim 1, wherein the plurality of retention features comprise clips configured to elastically deflect during insertion into the opening.

6. The adaptive grommet of claim 5, wherein the clips are distributed about a perimeter of the apron.

7. The adaptive grommet of claim 6, wherein the apron includes a plurality of clips arranged on each of four sides.

8. The adaptive grommet of claim 1, wherein the apron defines a gap between an underside of a lip and an upper surface of the retention features, the gap being configured to receive a portion of the component.

9. The adaptive grommet of claim 1, wherein the adaptive grommet includes at least one notch associated with the bend axis and configured to facilitate bending of the adaptive grommet along the bend axis.

10. The adaptive grommet of claim 9, wherein the at least one notch comprises a pair of aligned notches defining the bend axis.

11. The adaptive grommet of claim 10, wherein the notches reduce a thickness of material of the apron at the bend axis to facilitate bending.

12. The adaptive grommet of claim 10, wherein an additional notch is positioned to permit bending about an axis transverse to the bend axis.

13. The adaptive grommet of claim 1, wherein the grommet body defines a grommet opening.

14. The adaptive grommet of claim 13, wherein the grommet opening is generally circular.

15. The adaptive grommet of claim 13, wherein the grommet opening is offset relative to a geometric center of the grommet body.

16. The adaptive grommet of claim 1, wherein the grommet body is generally planar and defines a generally rectangular perimeter.

17. The adaptive grommet of claim 1, wherein the grommet body is solid and omits an opening.

18. The adaptive grommet of claim 1, wherein the grommet body and the apron are formed as a unitary structure.

19. The adaptive grommet of claim 1, wherein the grommet body and the apron are separately formed and joined together.

20. The adaptive grommet of claim 1, wherein the adaptive grommet is formed from a polymeric material.
